(19) United States
(12) Patent Application Publication
(10) Pub. No.: US 2003/0206728 A1
(43) Pub. Date: Nov. 6, 2003

(54) Information recording method, information recording medium, information playback method, and information playback apparatus

(75) Inventors: Teiichi Ichikawa, Akishima-shi (JP); Yumiko Taga, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/411,372

(22) Filed: Apr. 11, 2003

(30) Foreign Application Priority Data
Apr. 12, 2002 (JP) 2002-110782

(51) Int. Cl. H04N 5/781

(52) U.S. Cl. 386/125; 386/126

(57) ABSTRACT

An information recording medium has a first recording area that records DVD video data complying with the DVD video standard, and a second recording area that records playback control information, which is used to control playback of object information contained in the DVD video data, and which is not specified by the DVD video standard.

### CROSS-REFERENCE TO RELATED APPLICATIONS

This application is based upon and claims the benefit of priority from the prior Japanese Patent Application No. 2002-110782, filed Apr. 12, 2002, the entire contents of which are incorporated herein by reference.

### BACKGROUND OF THE INVENTION

1. Field of the Invention

The present invention relates to a DVD (Digital Versatile Disk) video data recording method complying with the DVD video standard. The present invention also relates to an information recording medium on which DVD video data complying with the DVD video standard can be recorded. Furthermore, the present invention relates to a playback method and apparatus for DVD video data, which is recorded on the information recording medium, and complies with the DVD video standard.

2. Description of the Related Art

In recent years, DVDs have been developed as high-density recording media, and a playback apparatus that plays back a DVD or which has been recorded DVD video data complying with the DVD video standard has prevailed. The DVD video standard makes it possible to store DVD video data in a DVD video area on the DVD, and also to store an HTM file, program file, or the like in an area other than the DVD video area (to be referred to as a ROM area hereinafter).

DVD video data contains PGC (Program Chain) information and VOB (Video Object) information. The PGC information controls playback of VOB information. For this reason, playback of VOB information is limited by the PGC information complying with the DVD video standard, and has a low degree of freedom.

### BRIEF SUMMARY OF THE INVENTION

The present invention has been made in consideration of the above situation and has as its object the provision of an information recording method which records video data that allows playback not specified by the DVD video standard and that complies with the DVD video standard.

An information recording method of the present invention comprises the step of recording DVD video data complying with the DVD video standard on a predetermined recording medium, and recording playback control information, which is used to control playback of object information contained in the DVD video data and which is not specified by the DVD video standard.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing a DVD video disk, and a playback apparatus and method for playing back the DVD video disk, according to a first embodiment of the present invention;

FIG. 2 is a schematic diagram showing a DVD video disk, and a playback apparatus and method for playing back the DVD video disk, according to a second embodiment of the present invention;

FIG. 3 is a schematic diagram showing a DVD video disk, and a playback apparatus and method for playing back the DVD video disk, according to a third embodiment of the present invention;

FIG. 4 is a schematic diagram showing a DVD video disk, and a playback apparatus and method for playing back the DVD video disk, according to a fourth embodiment of the present invention;

FIG. 5 is a schematic diagram showing a DVD video disk, and a playback apparatus and method for playing back the DVD video disk, according to a fifth embodiment of the present invention;

FIG. 6 is a diagram showing an example of a DVD video disk on which is stored an extended playback control file depending on PGC information, and a playback apparatus which has no extended playback function;

FIG. 7 is a flowchart for explaining the formatting (recording) process of a DVD video disk;

FIG. 8 is a flowchart for outlining a playback process;

FIG. 9 is a diagram showing an example of a DVD video disk on which is stored an extended playback control file depending on PGC information, and a playback apparatus which has an extended playback function; and

FIG. 10 shows an example of the data structure of DVD video data stored on a DVD video disk.

### DETAILED DESCRIPTION OF THE INVENTION

Preferred embodiments of the present invention will be described hereinafter with reference to the accompanying drawings.

As described above, the DVD video standard makes it possible to store an HTM file, program file, or the like in a ROM area. For example, an extended playback control file is recorded in this ROM area. Use of this extended playback control file allows more interactive playback regardless of the DVD video standard.

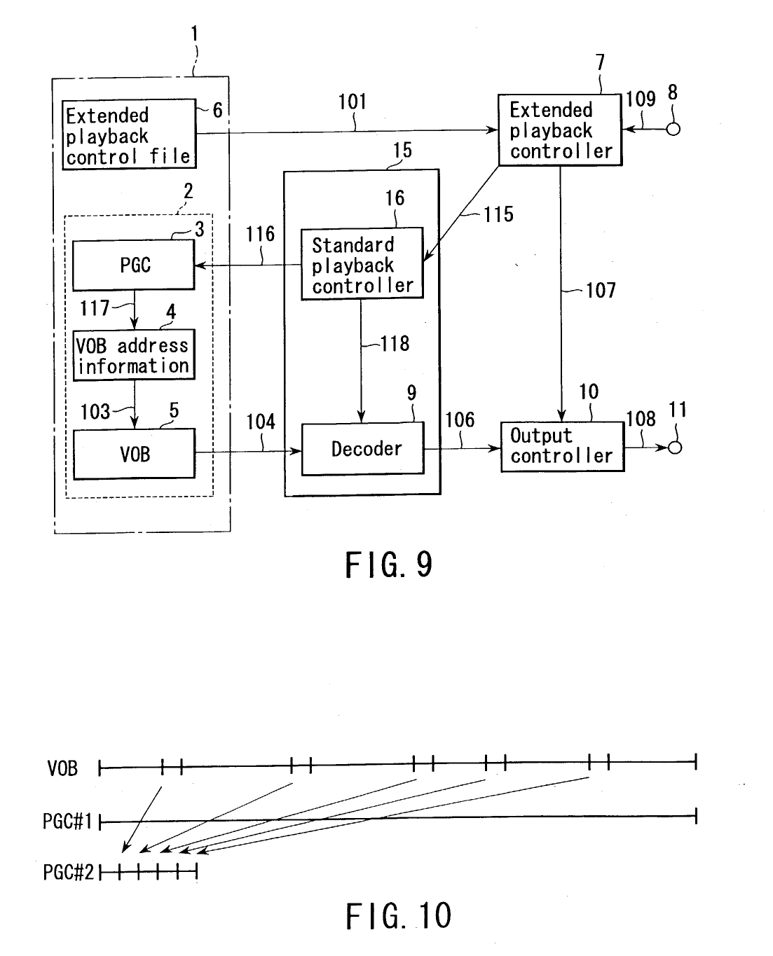

FIG. 9 shows an example of a DVD video disk on which is stored an extended playback control file, and a playback apparatus which plays back this DVD video disk.

In a DVD video area 2 on a DVD video disk 1, data complying with the DVD video standard can be recorded. DVD video data can be roughly classified into Video Objects (to be referred to as VOBs hereinafter) 5 having content such as video, audio, sub-pictures, and the like, and a Program Chain (to be referred to as a PGC hereinafter) 3 that specifies the playback order of the VOBs.

A playback apparatus implements playback control of PGC information, and indirectly decodes and plays back VOBs described in the PGC information. In this case, VOB address information 4 is also recorded in the DVD video area. With reference to this VOB address information 4, the address of a VOB to be played back can be obtained.

A DVD video playback unit 15 has a standard playback controller 16 and decoder 9. The standard playback controller 16 reads out a VOB 104 to be played back based on the address information 4 to the decoder 9 on the basis of user operation information 109 input from a terminal 8, and the PGC information read out from the DVD video disk 1. The decoder 9 plays back the read-out VOB 104 on the basis of a control signal 118 input from the standard playback controller 16, and outputs a playback signal 108 to a terminal 11.

In a playback apparatus which has no extended playback control means, as shown in FIG. 6, even when a DVD video disk 1 having an extended playback control file 6 is to be played back, playback control is executed with reference only to information in the DVD video area 2 on the DVD video disk 1 without referring to the extended playback control file 6.

FIG. 9 is a diagram showing an example of a DVD video disk on which is stored an extended playback control file, and a playback apparatus which plays back the contents in a DVD video area on the basis of the extended playback control file on this DVD video disk.

As shown in FIG. 9, the playback apparatus has an extended playback controller 7. The extended playback controller 7 reads out an extended playback control file 6 recorded in a ROM area of a DVD video disk 1. The extended playback control file 6 designates playback contents in the DVD video area on the basis of PGC information, and the extended playback controller 7 informs a standard playback controller 16 in a DVD video playback unit 15 of PGC information (or its part) to be played back on the basis of user operation information 109 input from a terminal 8, and the extended playback control file 6 read out from the DVD video disk 1. The DVD video playback unit 15 decodes and plays back a designated VOB based on the PGC information, and outputs a playback signal 106 to an output controller 10. The output controller 10 outputs a playback signal 108 to a terminal 11 on the basis of a control signal and extended playback signal 107 output from the extended playback controller.

FIG. 10 shows an example of the data structure of DVD video data stored in a DVD video disk.

For example, in a DVD video area 2, a video sequence is recorded as VOB#1. PGC#1 defines playback of this whole video sequence. In addition, in VOB#1, five specific scenes (e.g., scenes in which a given character appears) are defined as cells. PGC#2 extracts only these five specific scenes, and defines their playback.

A DVD extended playback control area 6 records a playback control information file that accesses PGC#2. The playback apparatus shown in FIG. 6 can only play back the whole video sequence recorded as VOB#1 by playing back PGC#1. On the other hand, the playback apparatus which has the extended playback control function, as shown in FIG. 9, can also execute a playback process that synchronously displays a signal obtained by playing back PGC#2 via the DVD extended playback control area 6, and related information 107 recorded in the DVD extended playback control area 6 via the output controller 10. In this case, the extended playback controller 7 can access not only a data file on the DVD video disk, but also external information of, e.g., the Internet, and can play back externally acquired information 107 and the DVD video signal 106 together.

The playback process described using FIGS. 6 and 9 is based on a file recorded in the ROM area of the DVD video disk 1, but consequently depends on PGC information of the DVD video disk 1. For this reason, playback control that extracts, e.g., 100 or more parts in one title cannot be implemented due to the limitation of the DVD video standard.

It is possible to implement such playback control by changing the configuration of the PGC Information in the DVD video area (e.g., segmenting one title into a plurality of titles). However, such change adversely influences standard playback. Upon additionally writing the extended playback control file 6 to a DVD video disk, which is formed without storing any extended playback control file 6, not only the extended playback control file 6 is merely added to the DVD video disk, but also PGC information in the DVD video area must be changed.

Hence, a file, which directly controls VOB data in the DVD video area independently of PGC information, is recorded in the ROM area, and playback control based on this file is proposed. As a result, playback control which is not limited by the conventional DVD video standard can be implemented.

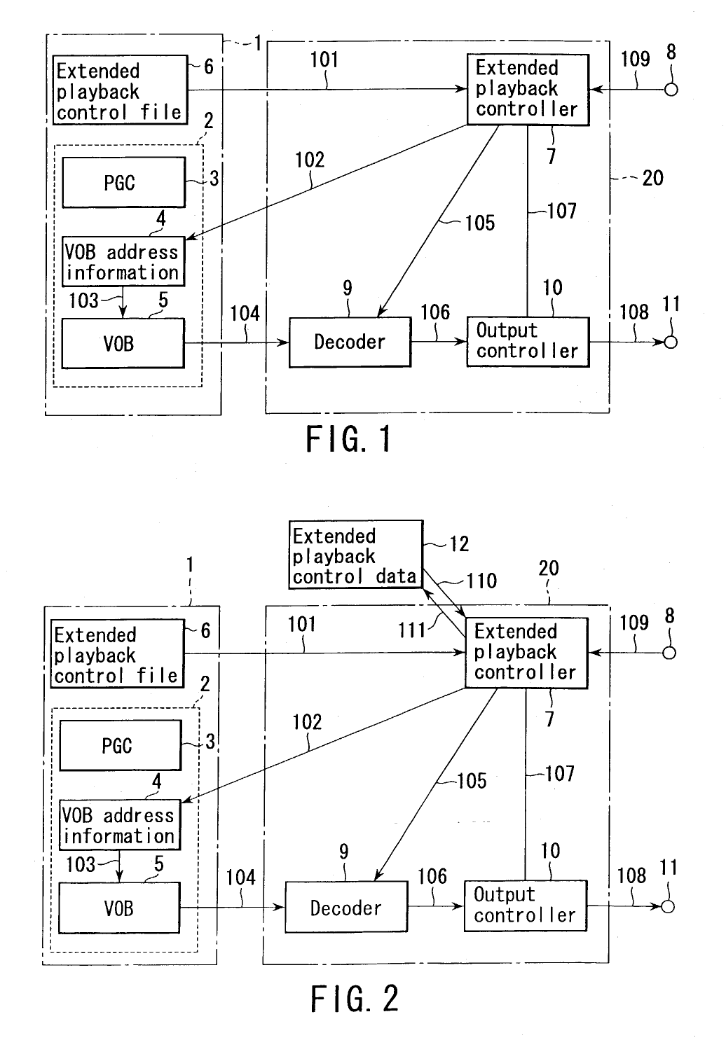

FIG. 1 is a schematic diagram showing a DVD video disk 1, a playback apparatus 20 that plays back this DVD video disk 1, and a playback method, according to the first embodiment of the present invention.

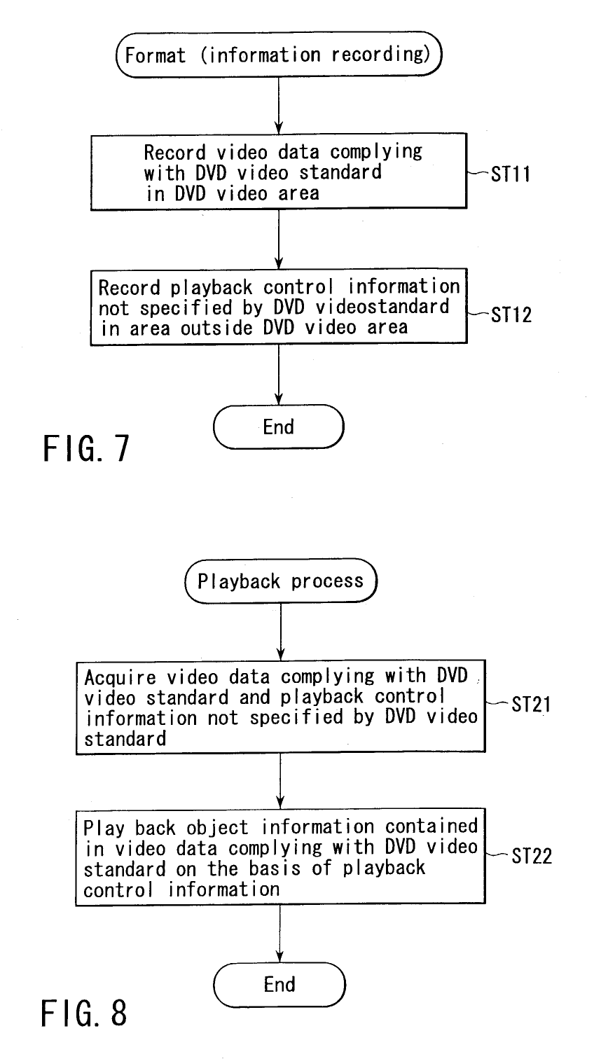

The DVD video disk 1 is produced by the formatting (information recording) process shown in FIG. 7. That is, DVD video data complying with the DVD video standard is recorded in the DVD video area 2 (ST11), and playback control information not specified by the DVD video standard is recorded in an area outside the DVD video area 2 (ST12). That is, the DVD video disk 1 comprises the DVD video area 2 in which DVD video data complying with the DVD video standard is recorded, and the area in which the playback control information not specified by the DVD video standard is recorded.

The DVD video data contains at least VOB information 5. In the first embodiment, the DVD video data also contains PGC information 3. The PGC information 3 can be considered as playback control information complying with the DVD video standard. The PGC information 3 may contain playback control information for all pieces of VOB information 5 contained in the DVD video data, but only playback control information for some pieces of VOB information 5. The playback control information not specified by the DVD video standard indicates an extended playback control file 6, which contains playback control information that controls playback of VOB information. This playback control information is described on a VOB basis. That is, the playback control information of the extended playback control file 6 is independent from PGC information. The extended playback control file 6 may contain playback control information for all pieces of VOB information 5 contained in the DVD video data, but only playback control information for some pieces of VOB information 5. For example, the PGC information 3 may contain playback control information for some pieces of VOB information 5 contained in the DVD video data, and the extended playback control file 6 may contain playback control information for the remaining pieces of VOB information 5 contained in the DVD video data. That is, the PGC information 3 and extended playback control file 6 may contain playback control information for all pieces of VOB information 5 contained in the DVD video data in combination.

PGC#2 described in FIG. 10 is not recorded in the DVD video area 2 shown in FIG. 1. The extended playback control file 6 contains playback control information that describes content to be played back on a VOB basis. That is, playback control information based on the extended playback control file 6 does not require any PGC information.

As shown in FIG. 8, the extended playback controller 7 reads out the extended playback control file 6 from the DVD video disk 1 (ST21). The controller 7 then reads out VOB data 104 to be played back via recording location information 102 and information 103 (VOB address information 4) on the basis of the user operation information 109 input from the terminal 8 and the extended playback control file 6 (ST21), and inputs the readout data to the decoder 9. The decoder 9 decodes the VOB data 104 on the basis of a control signal 105 input from the extended playback controller 7 to obtain a signal 106, and inputs the signal 106 to the output controller 10. The output controller 10 outputs a playback signal 108 to the terminal 11 on the basis of a control signal and extended playback signal 107 output from the extended playback controller 7 (ST22). In this manner, a playback process for synchronously displaying the playback signal 106 of the DVD video data and the related information 107 recorded in the extended area 6 on the DVD video disk 1 can be implemented. That is, by describing the extended playback control file 6, which is not limited by the DVD video standard, on the DVD video disk 1, for example, playback control that extracts 100 or more parts from one tile can be implemented.

Upon adding a new extended playback control file 6 to a DVD video disk which is produced without storing any extended playback control file 6, the extended playback control file 6 alone need be added to the ROM area in the disk without changing data in the DVD video area.

FIG. 2 is a schematic diagram showing a DVD video disk 1, a playback apparatus 20 that plays back this DVD video disk 1, and a playback method, according to the second embodiment of the present invention.

In this embodiment, content different from the first embodiment will mainly be explained. The DVD video area 2 in the DVD video disk 1 records VOB data which are not assigned to PGC information. The extended playback controller 7 acquires an extended playback control file 6 recorded on the DVD video disk 1, and also extended playback control data 12 from an external apparatus via the Internet or the like, i.e., a communication line. The externally acquired extended playback control data 12 has playback control information of the VOB data which are not assigned to PGC information 3. Acquisition of the extended playback control data 12 requires an authentication signal 111. That is, this authentication signal 111 is used to restrict acquisition of the extended playback control data 12. For example, a given fee is charged for acquisition of the extended playback control data 12. That is, only a user who has paid a given amount is permitted to acquire the extended playback control data 12. Or only a limited user is permitted to acquire the extended playback control data 12. In this manner, the user who has paid for acquisition or the limited user is allowed to play back specific content.

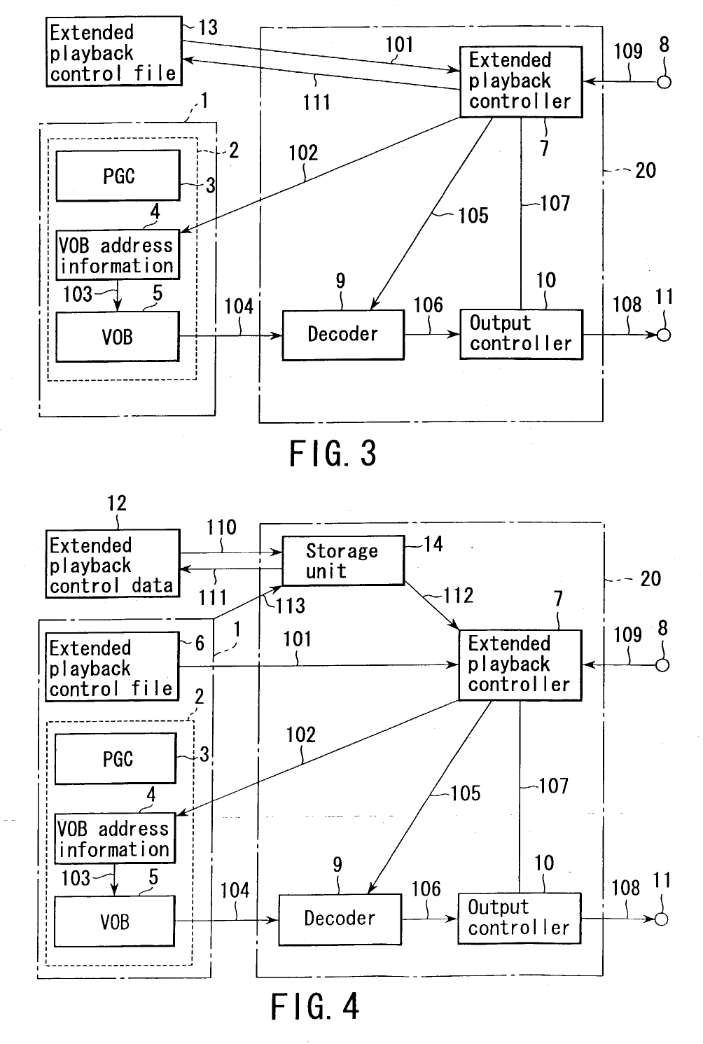

FIG. 3 is a schematic diagram showing a DVD video disk 1, a playback apparatus 20 that plays back this DVD video disk 1, and a playback method, according to the third embodiment of the present invention.

In this embodiment, content different from the first and second embodiments will mainly be explained. In the third embodiment, the extended playback control file 6 is not recorded on the DVD video disk 1. The extended playback controller 7 externally acquires an extended playback control file 13 via, e.g., the Internet. The externally acquired extended playback control file 13 has the same information as the extended playback control file 6 explained using FIG. 1. That is, according to the playback apparatus 20 shown in FIG. 3, even when the DVD video disk 1 which has no extended playback control file is to be played back, extended playback control can be implemented on the basis of the externally provided extended playback control file 13. An authentication signal 111 serves as identification information of the DVD video disk, playback of which is underway, and the extended playback control file 13 associated with the DVD video disk 1, playback of which is underway, can be acquired on the basis of this identification information.

FIG. 4 is a schematic diagram showing a DVD video disk 1, a playback apparatus 20 that plays back this DVD video disk 1, and a playback method, according to the fourth embodiment of the present invention.

In this embodiment, content different from the first, second, and third embodiments will mainly be explained. As shown in FIG. 4, the playback apparatus has a storage unit 14. Externally supplied extended playback information 12 is stored in the storage unit 14. In this case, the extended playback information 12 is stored in association with identification information 113 of the disk. When the extended playback information 12 of a given disk is stored in the storage unit 14, extended control based on the extended playback information stored in the storage unit 14 can be implemented without externally fetching the extended playback information 12 again on the basis of the identification information 113 upon playing back that disk. In this case, by setting an expiration date in the extended playback information, the extended playback information can be periodically updated, or the expiration date of the paid amount can be set.

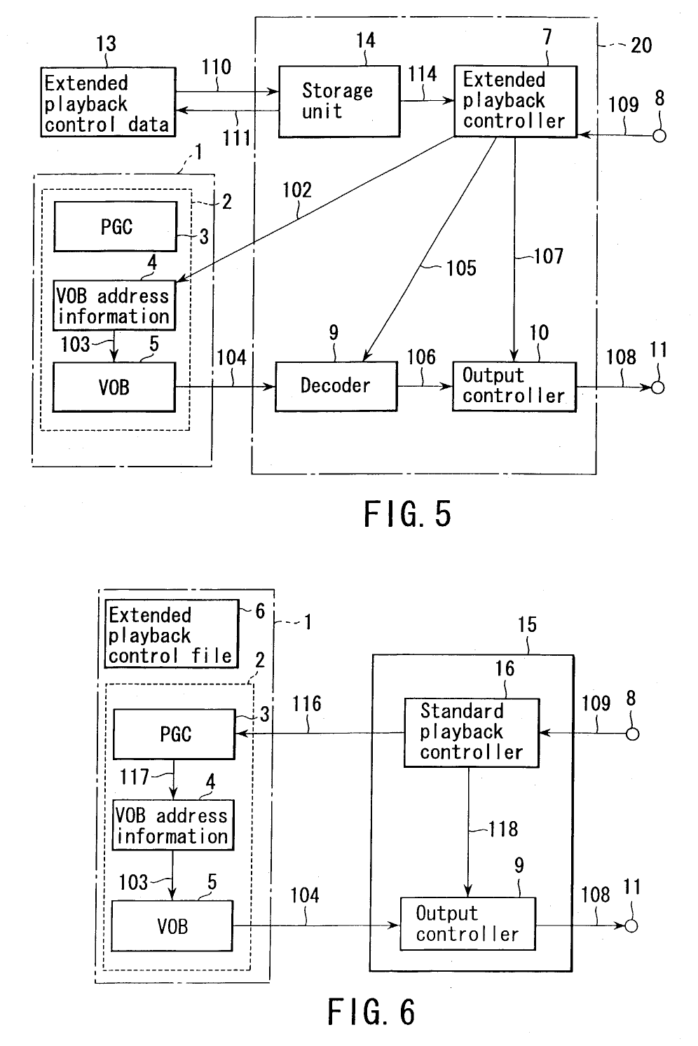

FIG. 5 is a schematic diagram showing a DVD video disk 1, a playback apparatus 20 that plays back this DVD video disk 1, and a playback method, according to the fifth embodiment of the present invention.

In this embodiment, content different from the first, second, and third embodiments will mainly be explained. As in the fourth embodiment, the playback apparatus has a storage unit 14, as shown in FIG. 5. Externally supplied extended playback information 13 is stored in the storage unit 14. In this case, the extended playback information 12 is stored in association with identification information 113 of the disk. When the extended playback information 13 of a given disk is stored in the storage unit 14, extended control based on the extended playback information stored in the storage unit 14 can be implemented without externally fetching the extended playback information 13 again on the basis of the identification information 113 upon playing back that disk.

The DVD video disk 1 shown in FIGS. 1, 2, and 4 is formatted by the following information recording method. That information recording method records DVD video data complying with the DVD video standard in the DVD video area 2 of the DVD video disk, and records an extended playback control file 6, which is used to control VOB information contained in the DVD video data but is not specified by the DVD video standard, in an area outside the DVD video area 2.

As a result of information recording by this information recording method, the DVD video disk 1 shown in FIGS. 1, 2, and 4 is produced. That is, the DVD video disk 1 comprises the DVD video area 2 in which is recorded DVD video data complying with the DVD video standard, and the area in which is recorded the extended playback control file, which is used to control VOB information contained in the DVD video data but is not specified by the DVD video standard.

According to the embodiments of the present invention, playback control, which cannot be implemented due to limitations of the conventional DVD video standard, can be implemented.

Also, according to the embodiments of the present invention, a DVD video disk having an extended playback control file can be produced by additionally recording only the extended playback control file without changing the configuration of the already produced DVD video data.

Furthermore, according to the present invention, playback based on an extended playback control file can be made even for already released DVD video disks by externally supplying the extended playback control file.

Moreover, according to the present invention, playback control according to a paid amount or expiration date can also be implemented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording method comprising:
recording DVD video data complying with the DVD video standard on a predetermined recording medium, and recording playback control information, which is used to control playback of object information contained in the DVD video data, and is not specified by the DVD video standard.

2. A method according to claim 1, wherein the DVD video data contains playback control information complying with the DVD video standard, and
the playback control information complying with the DVD video standard controls playback of some data in the object information.

3. An information recording medium comprising:
a first recording area that records DVD video data complying with the DVD video standard; and
a second recording area that records playback control information, which is used to control playback of object information contained in the DVD video data, and is not specified by the DVD video standard.

4. A medium according to claim 3, wherein the DVD video data contains playback control information complying with the DVD video standard, and
the playback control information complying with the DVD video standard controls playback of some data in the object information.

5. An information playback method comprising the steps of:
acquiring DVD video data complying with the DVD video standard, and playback control information, which is used to control playback of object information contained in the DVD video data, and is not specified by the DVD video standard; and
playing back the object information on the basis of the playback control information, which is not specified by the DVD video standard.

6. A method according to claim 5, wherein the DVD video data contains playback control information complying with the DVD video standard, and
the playback control information complying with the DVD video standard controls playback of some data in the object information.

7. A method according to claim 5, further comprising the step of acquiring the object information and the playback control information, which is not specified by the DVD video standard, from a predetermined information storage medium.

8. A method according to claim 5, further comprising the step of acquiring the object information from a predetermined information storage medium, and externally acquiring the playback control information, which is not specified by the DVD video standard, via a communication line.

9. A method according to claim 5, further comprising the step of acquiring the object information from a predetermined information storage medium, and externally acquiring the playback control information, which is not specified by the DVD video standard, via a communication line, on the basis of medium identification information held on the predetermined information storage medium.

10. A method according to claim 9, further comprising the step of storing the playback control information, which is not specified by the DVD video standard, and the medium identification information in association with each other.

11. A method according to claim 8, further comprising the step of acquiring the playback control information, which is not specified by the DVD video standard, under the condition that a given amount is paid.

12. A method according to claim 11, further comprising the step of acquiring the playback control information, which has the limitation of an expiration date according to a paid amount, and is not specified by the DVD video standard.

13. An information playback apparatus comprising:
an acquisition unit configured to acquire DVD video data complying with the DVD video standard, and playback control information, which is used to control playback of object information contained in the DVD video data, and is not specified by the DVD video standard; and
a playback unit configured to play back the object information on the basis of the playback control information, which is not specified by the DVD video standard.

14. An apparatus according to claim 13, wherein the DVD video data contains playback control information complying with the DVD video standard, and
the playback control information complying with the DVD video standard controls playback of some data in the object information.

15. An apparatus according to claim 13, wherein the acquisition unit acquires the object information and the playback control information, which is not specified by the DVD video standard, from a predetermined information storage medium.

16. An apparatus according to claim 13, wherein the acquisition unit acquires the object information from a predetermined information storage medium, and externally acquires the playback control information, which is not specified by the DVD video standard, via a communication line.

17. An apparatus according to claim 13, wherein the acquisition unit acquires the object information from a predetermined information storage medium, and externally acquires the playback control information, which is not specified by the DVD video standard, via a communication line, on the basis of medium identification information held on the predetermined information storage medium.

18. An apparatus according to claim 17, further comprising a storage unit configured to store the playback control information, which is not specified by the DVD video standard, and the medium identification information in association with each other.

19. An apparatus according to claim 16, wherein the acquisition unit acquires the playback control information, which is not specified by the DVD video standard, under the condition that a given amount is paid.

20. An apparatus according to claim 19, wherein the acquisition unit acquires the playback control information, which has the limitation of an expiration date according to a paid amount, and is not specified by the DVD video standard.
